(19) United States
(12) Patent Application Publication
(10) Pub. No.: US 2013/0316172 A1
(43) Pub. Date: Nov. 28, 2013

(54) CARBON NANOTUBE ELONGATES AND METHODS OF MAKING

(71) Applicants: Vesselin N. Shanov, Cincinnati, OH (US); Mark J. Schulz, West Chester, OH (US); Gary Martin Conroy, Cincinnati, OH (US)

(72) Inventors: Vesselin N. Shanov, Cincinnati, OH (US); Mark J. Schulz, West Chester, OH (US); Gary Martin Conroy, Cincinnati, OH (US)

(73) Assignee: GENERAL NANO LLC, Cincinnati, OH (US)

(21) Appl. No.: 13/982,934

(22) PCT Filed: Feb. 1, 2012
(86) PCT No.: PCT/US12/23447

§ 371 Date: Jul. 31, 2013

Related U.S. Application Data
(60) Provisional application No. 61/438,337, filed on Feb. 1, 2011.

(51) Int. Cl. C01B 31/02

(52) U.S. Cl. CPC C01B 31/0253
USPC 428/367; 427/458

(57) ABSTRACT

A method using of electrostatic spraying or dispersing processes and techniques for depositing a particulate material onto the outside surfaces of carbon nanotubes (CNTs) and CNT elongates consisting of the CNTs. The particulate material can include either or both particles and droplets, and the material can be an element, compound or composition, including polymers and thermoplastics. The particulate material is dispersed and induced with a static charge, while the CNT elongate is grounded.

### FIELD OF THE INVENTION

The present invention relates generally to a coated carbon nanotube or an arrangement containing carbon nanotubes, more particularly, to an electrostatic process for applying a material or polymer onto a carbon nano tube elongate.

### BACKGROUND OF THE INVENTION

Carbon nanotubes (CNT(s)) are increasingly being used in a variety of applications, including both new uses and as a replacement element in a conventional use. CNTs are finding use as a raw material in a coating formulation, and a variety of other uses, Elongated CNTs have been pulled from an array of aligned CNTs grown on a substrate and spun into CNT yarns, as described in Zhu, WO 2006/073460, and in Zhang 2008/0170982 the disclosures of which are incorporated herein by reference in their entirety.

Individual CNT or the CNT ribbons or threads have been contacted with liquid composition in order to enhance their use for particular applications. CNT yarns have been wet coated with an insulative coating material applied onto the surface of the CNT yarn to enhance their properties, as described in Zhu, US 2009/0208742 (dripping polymer onto CNT yarn), Zhang, WO 2007/015710 (spraying), and Otobe, U.S. Pat. No. 7,357,984, (adsorption from dipping CNT in solution), the disclosures of which are incorporated herein by reference in their entirety. However, such wet coating processes described are often associated with low coating speeds, or generate either a thick or non uniform coating, or otherwise have undesirable features.

Collier, US 2005/0208304, incorporated herein by reference, describes a plasma coating process for coating a CNT inside of another CNT, where a plasma coating formulation is introduced into the outer CNT. The plasma then envelopes the inner CNT and deposits a coating on surfaces of the inner CNT. The plasma coating process uses a furnace at a temperature of 950 degrees Celsius.

Thus there remains a need for CNTs and CNT elongates having improved properties, and for a process for applying a material to CNT elongates that avoids the drawbacks of conventional contacting and coating processes.

### SUMMARY OF THE INVENTION

The present invention relates to the use of electrostatic spraying or dispersing processes and techniques for depositing a particulate material onto the outside surface of CNTs and CNT elongates comprising the CNTs. The particulate material can include either or both solid particles and liquid droplets, and the material can be an element, compound or composition. The particulate material is dispersed and induced with an electrostatic charge, while the CNT elongate is either grounded or induced with an opposing static charge.

An aspect of the invention includes a method of coating a carbon nanotube elongate, comprising the steps of: (i) grounding a carbon nanotube elongate, (ii) dispersing statically-charged droplets of a polymer solution comprising a polymer, in the vicinity of the grounded carbon nanotube (CNT) elongate, (iii) contacting the statically-charged droplets with the surface of the grounded CNT elongate, (iv) maintaining the contacted droplets in contact with the surface of the grounded CNT elongate under conditions and for a time sufficient for the polymer solution to coat at least a portion of the surface, and (v) optionally curing the coated polymer in the polymer solution. The steps of contacting and coating can include completely coating of the surface of the ground CNT elongate. The polymer can be an electrically insulating polymer, and the polymer solution can comprise a solvent. The polymer coating can include a uniform and thin coating that covers the entire circumferential surface of the CNT elongate. The CNT elongate can include a CNT strand, a CNT ribbon, a CNT thread, a CNT yarn, a CNT braid, a CNT rope, and a CNT wire.

Another aspect of the invention is a coated carbon nanotube (CNT) elongate comprising a CNT with a coating of a polymer covering at least a portion of the surface of the CNT elongate. The polymer coating can include a uniform and thin coating that covers the entire circumferential surface of the CNT elongate.

Another aspect of the invention is a method of depositing a particulate material onto the surface of a carbon nanotube (CNT) elongate, comprising the steps of: (i) grounding a CNT elongate, (ii) dispersing statically-charged particles of a material in the vicinity of the grounded CNT elongate, (iii) contacting the statically-charged particles with the surface of the grounded CNT elongate, (iv) maintaining the contacted particles in contact with the surface of the grounded CNT elongate under conditions and for a time sufficient for the particles to affix to the surface. The particulate material includes a solid, liquid or molten particle of an element, compound or composition.

### BRIEF DESCRIPTION OF THE DRAWINGS

The present invention will be understood more fully from the detailed description that follows and from the accompanying drawings, which however, should not be taken to limit the invention to the specific embodiments shown, but are for explanation and understanding only.

FIG. 1 illustrates a schematic of an electrostatic coating process including grounding of carbon nanotube elongates and contacting the grounded carbon nanotube elongate with a coating material.

FIG. 2 illustrates a process of continuously drawing CNT strands and ribbons from an array of aligned CNTs.

FIG. 3 illustrates an electrostatic coating process for carbon nanotube elongates, illustrated as the CNT strands and ribbons drawn from the array of aligned CNTs, the process including grounding of the carbon nanotube elongate, dispersing of electrostatically-charged coating particles, and contacting and coating of the CNT elongate with the electrostatically-charged coating particles, and forming the coating on the CNT elongate.

FIG. 4 illustrates a plurality of CNT strands and ribbons during coating with a coating material, taken through line 4-4 of FIG. 3.

FIG. 5 illustrates a coated carbon nanotube elongate following the application of the coating material, taken through line 5-5 of FIG. 3.

FIG. 6 illustrates an electrostatic coating process similar to that shown in FIG. 3, except that the electrostatically-charged coating particles contact and coat the carbon nanotube elongate after the spinning of the strands and ribbons of CNTs into a CNT thread.

FIG. 7 illustrates a coated carbon nanotube elongate following the application of the coating material, taken through line 7-7 of FIG. 6.

FIG. 8 illustrates an electrostatic coating process wherein the electrostatically-charged coating particles contact and coat a plurality of CNT threads.

FIG. 9 illustrates the process of coating the CNT threads, taken through line 9-9 of FIG. 8.

FIG. 10 illustrates the coated carbon nanotube threads elongate following the application of the coating material to form a coated CNT yarn, taken through line 10-10 of FIG. 8.

FIG. 11 shows a diagram of a flow-limited field-injection electrostatic spraying (FFESS) device.

FIG. 12 shows an electron micrograph image of a coated CNT yarn using butyrate polymer in a toluene solvent.

FIG. 13 shows an electron micrograph image of a coated CNT yarn using butyrate polymer in a toluene solvent.

### DETAILED DESCRIPTION OF THE INVENTION

In the following description specific details are set forth, such as a process for coating a carbon nanotube (CNT) ribbon, a polymer coating solution, and a particular type of electrostatic coating equipment, etc., in order to provide an understanding of the present invention, which in no way limits the scope of the present invention.

### Definition

A carbon nanotube elongate (CNT elongate) means a plurality of carbon nanotubes, including a CNT strand, a CNT ribbon, a CNT thread, a CNT yarn, a CNT braid, and a CNT wire or rope.

A CNT forest is a plurality of as-grown CNTs grown and disposed on a catalyst substrate, which can include a plurality of generally aligned, elongated single wall carbon nanotubes (SWCNT), double wall carbon nanotubes (DWCNT), multi-wall carbon nanotubes (MWCNT), or any combination or mixture thereof.

A CNT strand means a plurality of individual CNTs that are associated and in loose physical contact, typically held together by at least van der Waals forces when pulled from a CNT forest.

A CNT ribbon means a plurality of individual CNTs or strands of CNTs pulled from a CNT forest in a fan-like pattern. The fan-like pattern typically converges into a single CNT elongate thread.

A CNT thread is one or more CNT ribbons that have been mechanically converged and/or physically compressed into intimate contact, and held together both by van der Waals forces and other mechanical or chemical forces. An example of a CNT thread is a CNT ribbon that has been drawn into a single thread, and which can be twisted (around the axis of the ribbon), or that has been cohesively compressed by application of a liquid material onto the CNT ribbon.

A CNT yarn is an elongated structure made from a plurality or multi-ply of CNT threads, or simply a thicker thread.

A CNT braid is an elongated structure made from a plurality of CNT threads, or CNT yarns, which are interwoven in a particular pattern.

A CNT wire or rope includes at least one CNT thread, CNT yarn, or CNT braid, and optionally at least one other fiber.

The term “grounding” refers to placing a carbon nanotube (CNT) elongate into electrical communication with a ground that serves as the reference point in an electrical circuit from which other voltages are measured, and/or as a return path for electric current directly or indirectly to Earth.

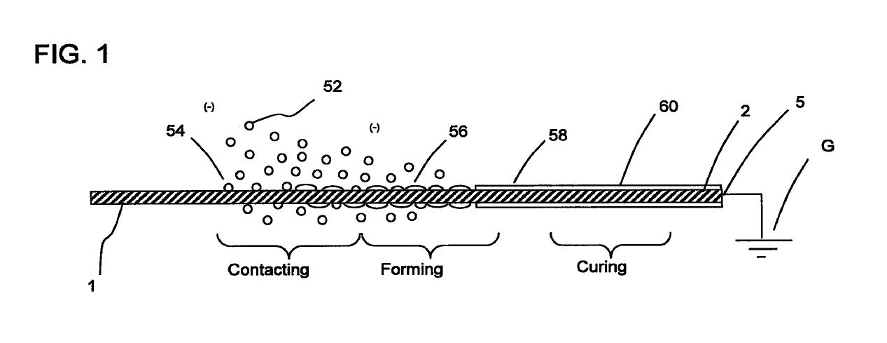

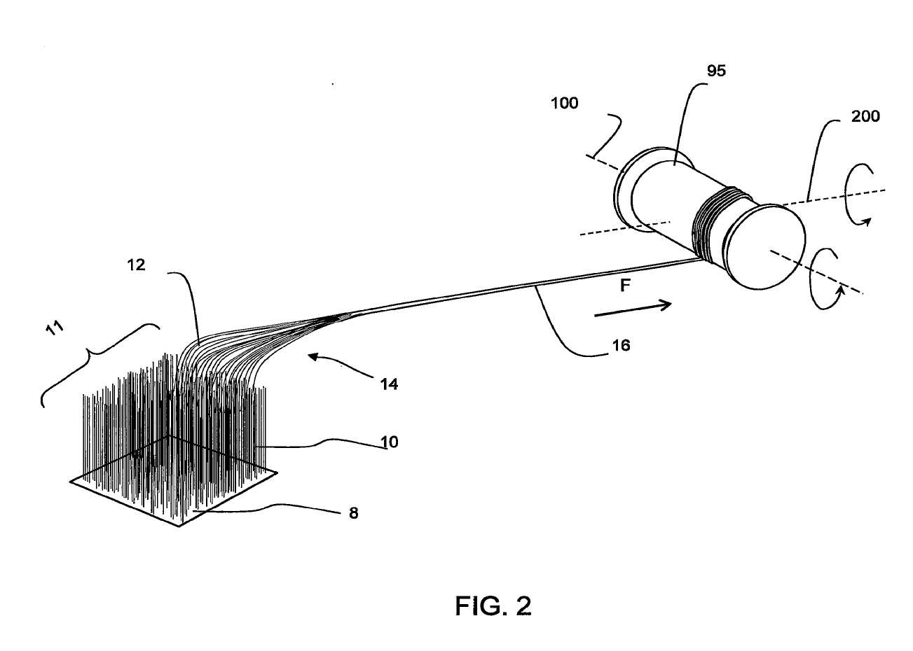

FIG. 1 illustrates a general schematic diagram of an electrostatic process including grounding of a carbon nanotube (CNT) elongate 1 and contacting the grounded carbon nanotube elongate with a dispersed particulate material, illustrated as a droplet 52 for coating the CNT elongate 1. The CNT elongate 1 is illustrated as having a terminal end 5 connected to ground G. The CNT elongate 1 can include a CNT strand consisting of one or more individual CNTs, a CNT ribbon typically consisting of a plurality of CNT strands, a CNT thread typically consisting of a one or more CNT ribbons drawn into a single elongated thread, a CNT yarn typically consisting of a plurality of CNT threads, a CNT braid, or a CNT wire or rope. The CNT elongate is comprised of multitude of carbon nanotubes (CNTs) that can be single walled, double walled or multi walled tubes, and which are typically grown on the surface of a catalyst substrate 8 (as shown in FIG. 2). The grown CNTs are generally aligned along a common axis, extending perpendicular to the substrate surface.

A multitude of the statically charged (negative) particles (droplets) 52 of the coating material, typically a polymer, are produced, induced with a static charge, and dispersed in the vicinity of the grounded CNT elongate 1. The charged droplets 52 are attracted statically to the exposed surface 2 of the grounded CNT elongate. Upon contact of the droplets 52 with the surface 2 of the CNT elongate, the electrons flow from the charged droplet into the CNT elongate, and to ground. The grounded droplet 54, in a molten or liquid form, then spread from its point of contact across and around the exposed surface of the CNT elongate to provide at least a partial coating 56 onto the surface of the CNT elongate. Charged droplets 52 continue to be attracted to and contact any exposed, uncoated surfaces of the partially coated CNT elongate, until the outer surface of the CNT elongate has been coated with a continuous layer 58 of the polymer composition. The maintaining of time for the formation of the continuous layer 58 as illustrated is optional and non-limiting to the invention. The coating could also be comprised of droplets that contact the CNT elongate but do not merge or otherwise do anything after contact. The continuous coating layer 58 optionally cures into a finished coating 60, as described herein

FIG. 2 illustrates a process to initiate and form an CNT elongate, wherein bunches of CNTs (which can include tens, to hundreds, to thousands or more of individual CNTs 10) are grasped, such as with tweezers, and pulled from the forest 11 into uncoated strands 12. The number of CNTs in a strand 12, and the diameter or lateral dimension of the strand 12, depends in large part on the means for grabbing and isolating CNTs, such as the tip size of the tool or device that grasps the ends of the CNTs disposed on the catalyst substrate, substantially as described in Jiang (Nature, vol 419, page 801, Oct. 24, 2002, Nature Publishing Group), the disclosure of which is incorporated herein by reference. The CNTs in the uncoated strands 12 stick to and are pulled by one another, and with continued application of elongating force F along their mutual axes, the uncoated strands 12 are drawn from along the edge of the CNT forest 11. As the plurality of uncoated strands are drawn along a common axis by an elongating force F, the plurality of strands associate and form an uncoated CNT ribbon 14 as a fan-like pattern that converges into an uncoated CNT thread 16. The elongating force F can be applied by a mechanical means for drawing the CNT elongate, resulting in an uncoated CNT thread 16 that is gathered and stored at a collection point, such as a collecting spool 95 revolving about axis 100. As the uncoated ribbon 14 is drawn along by the elongating force F, the CNTs and CNT strands 12 both self-align and compact into an uncoated CNT thread 16. The compaction of the CNTs into the thread 16 can be promoted by twisting or spinning of the threads around the common axis of the CNT thread, such as by rotating the spool 95 around axis 200.

A CNT forest 11 is provided that is grown on a catalyst substrate 8.

Examples of processes for growing aligned CNTs on a substrate are described in Ermolov, US Publication 2010/0163844A1, Shanov et al, US Publication 2008/0095694A1, and Tang, US Publication 2006/0068096A1, the disclosures of which are incorporated herein by reference. Preferred catalysts including an Fe-lanthanide, Fe—Co, and a Fe—Co-lanthanide alloy or composite catalyst. The typical height (length) of the aligned CNTs is at least 0.5 mm (500 nm), and up to about 2 cm, and more, more typically up to about 5 mm.

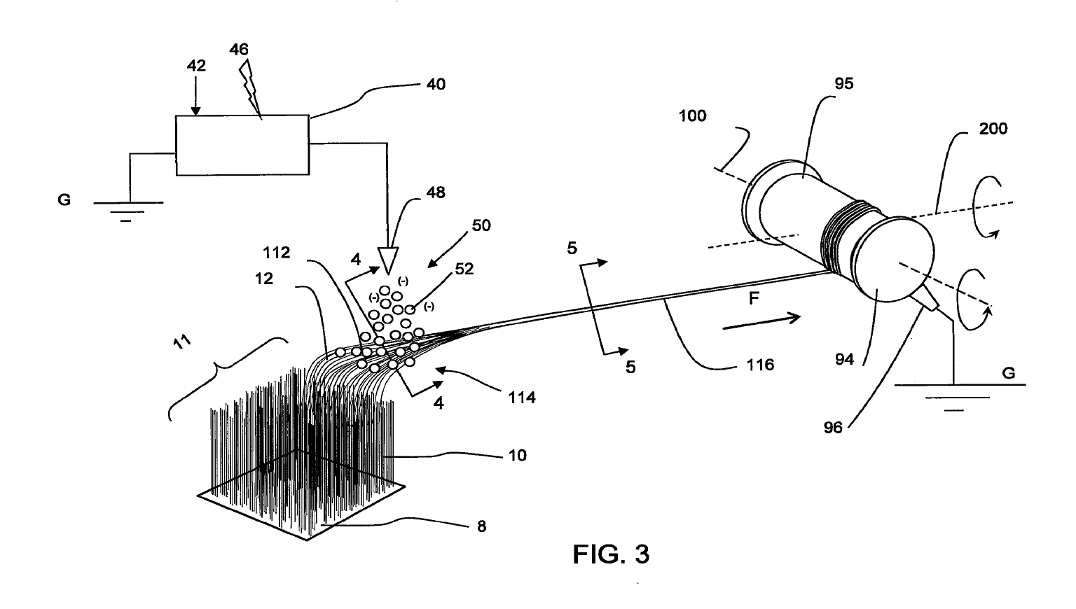

FIG. 3 illustrates a process for depositing a dispersed material onto the surface of and coating of the CNT elongates, including grounding of carbon nanotube elongates, dispersing of electrostatically-charged particles, targeting and contacting the dispersed, charged particles onto the grounded CNT elongate, and maintaining the contacted particle in contact with the CNT elongate surface for a time and under conditions sufficient to form a coating on the CNT elongate. In an aspect of the invention, the coating covers the entire surface of the CNT elongate, and is thinner and more uniformly applied as compared to conventional processes such as non-static spraying of CNT threads with, or dipping of CNT threads through or with, a coating liquid. In an embodiment of the invention, the contacting particle of material is a droplet of a polymer solution, typically comprising a solvent.

As an aspect of the invention is to obtain a thin and uniform coating that completely covers the outer surfaces of the CNT strands, threads or yarns, a sufficient quantity and rate of application of the polymer solution is provided. If too little (quantity) of polymer solution is provided, then the coating may not be complete and continuous, and opening in the coating may appear. If too much (quantity) or too high a rate of coating solution is applied, the excess solution may causes beading or pooling of the polymer solution along the surface of the CNTs elongates. Such beading or pooling can also be caused by an excessively think or runny polymer solution having a low viscosity, typically from excess solvent, which causes the coating solution to pool into beads before the coating can thicken and cure.

In the illustrated process of the present invention shown in FIG. 3, a plurality of uncoated strands 12 of the ribbon 14 of CNTs are drawn through a cloud or dispersion 50 of the statically charged droplets 52 of polymer. A cloud 50 of droplets 52 is produced by a device 40 that disperses and statically charges the stock polymer 42 through an appropriate delivery head 48, such as a nozzle tip. The droplets 52 are produced to minimize diameter or size, and are produced in a quantity sufficient, in this illustration, to cover at least partially and more typically completely the outer surfaces of the CNT elongates (here, the CNT strands 12 of the ribbon 14). The process for the preparation of statically charged droplets 52 of the polymer includes incorporating a unipolar charge 45 into the stock material 42 prior to dispersion. Alternatively the unipolar charge can be induced while forming or after forming the droplets, for example by using an inductor ring that is electrically charged and surrounds the dispersed droplets to impart the dielectric charge thereon, such as is described in Inculet, U.S. Pat. No. 5,400,975, the disclosure of which is incorporated by reference.

Without being bound by any particular theory, the small droplets 52 of polymer solution are repelled from one another and avoid coalescing into larger droplets, white simultaneously competing for space on the surface of the grounded CNT elongate. The droplets 52 in this illustration contact the surface, and flow or spread along the surface of the CNT elongate to completely cover the surface of the CNT elongate with a thin, uniform coating of the polymer. The resulting coated CNT elongate has a more uniform and thinner coaling than can be achieved with conventional processes.

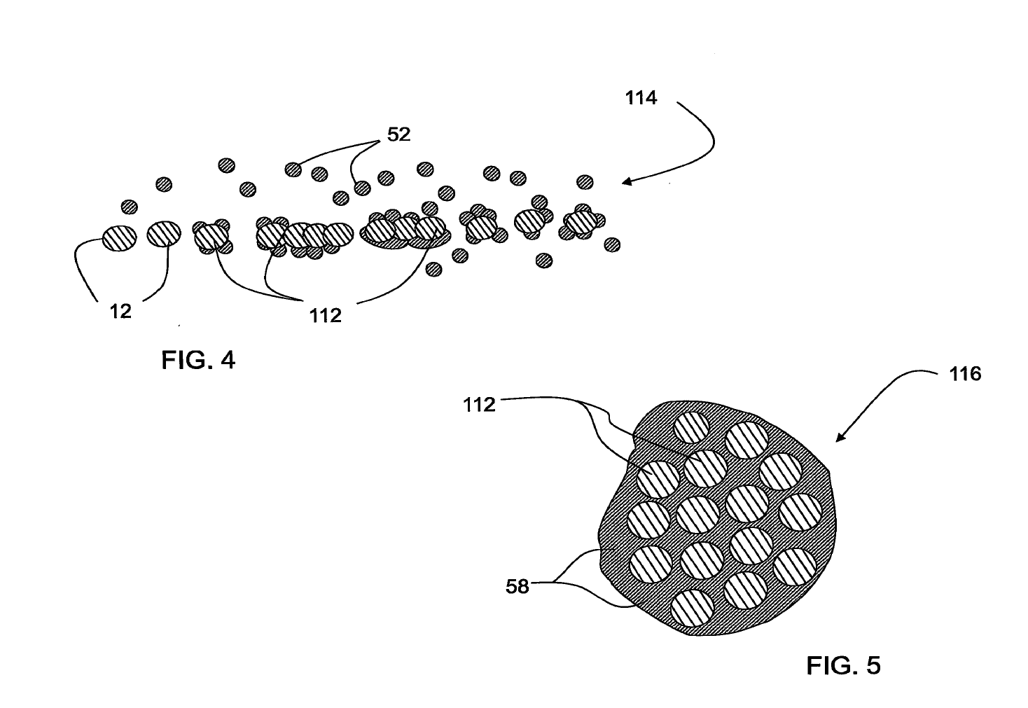

FIG. 4 illustrates a sectional view through the uncoated CNT strands 12 as these pass through the dispersed droplets 52. As these are drawn through the dispersion cloud 50, the polymer droplets 52 contact the outside surface of the CNT strands 12 of the ribbon 114, spreading and coating substantial portions of the outside of the strands to form coated CNT strands 112 and a coated CNT ribbon 114.

As shown in FIG. 5, the coated CNT strands 112 of the ribbon 114 are converged, and optionally twisted or spun, into a coated thread 116. The polymer material 58, in this illustration, has completely coated the surface of each exposed CNT strand 112, and the CNT thread 116, thereby isolating electrically the individual coated CNT strands 112 of CNTs, from one another laterally, that is, in a direction transverse to the longitudinal direction of the elongate.

In other aspects of the invention, the dispersed material can include solutions or colloids of elements, compounds or compositions (aqueous, polar or non-polar), and including monomers and polymers, including thermoplastics. Molten polymer can be heated to and dispersed at a temperature at or above the glass transition temperature, or above the melting point, of the polymer, and the conditions, such as temperature, of the contacted polymer maintained for a time sufficient for flowing and covering of the surface of the CNT. The solutions or colloids include a volatile solvent or liquid which substantially evaporates under appropriate processing conditions. Depending on the viscosity and other properties of the solutions, the flowing and coating of the material over the surface of the CNT elongates are achieved.

The step of curing the coated CNT elongates can include evaporating of any volatile solvent, or simple cooling of the coated surface to a temperature below the glass transition temperature. The term glass transition temperature is used to define the temperature at which an amorphous material, such as a polymer or glass, changes from a brittle state to a plastic state. Curing of the coating is not limiting in the invention and is optionally based on the type of coating or contacting solution. The drawing together of CNT elongates by the surface coating is not limiting in the invention, and may or may not occur based on the type of coating particle chosen, if curing or evaporation of solvent occurs, and if the resultant surface coating is in a liquid or solid state. Curing of the polymer material after depositing and coating of the CNT elongate can include evaporation of the solvent contained in the dispersed solution with or without additional heating over time, as well as the curing by altering the chemical structure of material, including monomers in the coated surface of the CNT elongate, including by means of ultraviolet (UV) radiation, infrared (IR) radiation, and heat.

The polymer materials and monomers thereof can include a wide variety of properties for a variety of use applications, and can include, without limitation, poly(3-hexylthiophene), polyimide, poly(vinylpyrrolidone), polystyrene, poly(vinylalcohol), aDEVCON epoxy, polyanilines, polypyrroles, polythiophenes, polyphenylenes, polyarylvinylenes, polycarbonate, polyvinylbutyral, polymethyl methacrylate, polystyrene, polydibenzodisilaazepine, polyaniline, poly(vinylpyridine), poly(vinyl alcohol), polythiophene, poly(N-vinylcarbazole), poly(phenylene vinylene), polyethylene, polystyrene, polyethylene terephthalate, polyarylene ethylene, polydiacetylene, and butyrate.

Any solvents used in the dispersed material to solubilize, dissolve, suspend or plasticize the material can include polar and nonpolar solvents, and combinations thereof, and can be selected based on the properties and nature of the polymer or material, processing requirements and conditions, etc. Typical non-limiting examples of solvents include water, propanol, isopropanol, ethanol, methanol, ether, toluene, xylene, tetrahydrofuran (THF), acetone, ethyl acetate, N-methylpyrrolidone (NMP), dimethyl sulfoxide (DMSO), methylene chloride, methyl ethyl ketone (MEK), and any mixtures thereof. Non-polar solvents can function as a lubricant between CNTs, and may weaken their attractive forces.

FIG. 3 further illustrates an example of grounding of the CNT elongate. In the illustrated process, the resulting CNT threads 16 are wound onto a cylindrical take-up spool 91. Before initialing the electrostatic coating of the CNT elongate, a distal end of the uncoated CNT thread 16 (as shown in FIG. 2) is electrically connected to the metallic (electrically conductive) spool 91. A grounding brush 96 maintains electrical contact with the rotating rim 94 to ground the CNT elongate. As the coating processing continues, the processed CNT thread 116 is rolled onto the rotating spool 91 while maintaining the grounding of the CNT thread 116.

The coating of CNT strands and CNT thread affects their electrical conductivity properties (when the material or polymer is electrically insulating), and that of any CNT yarn or CNT braid produced therefrom, in terms of resistance (R), inductance (L) and conductivity. The coated CNT elongates also have improved mechanical and physical properties including increased modulus and strength. The improvement in mechanical properties, without being bound by any particular theory, is believed due to the polymer adhering and/or enveloping the CNT elongates, and the CNTs bonding to each other, thus transferring a greater shear load between CNTs than due to friction and van der Waals forces alone. The properties also can be improved during the curing step, when any solvent used in the polymer evaporate and surface tension forces causes the coating to shrink, and within it, the CNT thread to be further compressed in diameter. The smaller diameter alone increased the physical properties because the cross-sectional area decreased.

Statically charged droplets 52 of the polymer will preferentially migrate and attached to areas of the surface of the CNT elongate that are in closest proximity to the delivery head. Various means can also be used to focus or direct the charged particles along a predetermined path or towards a target zone, such as an emitter ring. One or more inductors or conductors can be used to guide the stream of dispersed charged droplets, and/or to direct the droplets to the grounded CNT elongate target. A modulating device can include a ring or roller(s) that are placed along the side or sides of the pathway of the dispersed droplets, and are electrically charged either with the same charge as the charged droplets to effect a repelling force on the droplets, or the opposite charge as the charged droplets to effect an attracting force on the droplets, as described in Escallon, U.S. Pat. No. 5,086,973, the disclosure of which is incorporated by reference in its entirely.

The dispersion device as used herein is not limiting to the invention and could be any device that creates a dispersion of electrostatically-charged coating particles by any means.

The type of dispersion device 50 and the approach for producing a cloud of droplets can include those used in Berkland, Biomaterials 25 (2004) 5649-5658, incorporated herein by reference, which creates electrostatically nano-sized charged polymer solution droplets from a variety of polymer materials, as well as those used in U.S. Pat. No. 4,761,299, issued to Hufstetler, incorporated herein by reference. Berkland describes a flow-limited field-injection electrostatic spraying (FFESS) technique capable of producing various controllable micro- and nano-structures. The FFESS technique provides enhanced control of surface morphology by injecting charge into a coating solution using a nano-sharpened tungsten electrode resulting in field ionization of the fluid and yielding finer droplet size and surface features than those attained using conventional electrospraying. The smooth glass nozzle employed to spray the fluid minimized imperfections in the surface from which the spray may originate thus increasing jet uniformity and stability. The parameters that can affect polymer jet performance can be investigated and manipulated as determined by Rayleigh's equation describing the formation of a charged jet. By manipulating applied voltage, solvent type, polymer solution flow rate, and polymer concentration, the uniformity, size and distribution of nano-sized particles can be produced by FFESS even when utilizing relatively non-conductive organic solvents. The tungsten needles for charge injection used in the FFESS device are available from Veridiam Point Technologies in Costa Rica. Flow tips were fabricated from glass capillaries pulled to a sharp point (50-500 μm). A device for pumping the coating solution can include a syringe pump, for example, a Harvard Apparatus 4400 at well-controlled flow rates. A controllable high-voltage source (Glassman High Voltage, Inc. Series EL) can be connected to the encased tungsten needle for applying a voltage (range of 0-30 kV) to the needle while polymer solution is pumped at the desired flow rates, resulting in fine sprays of polymer solution.

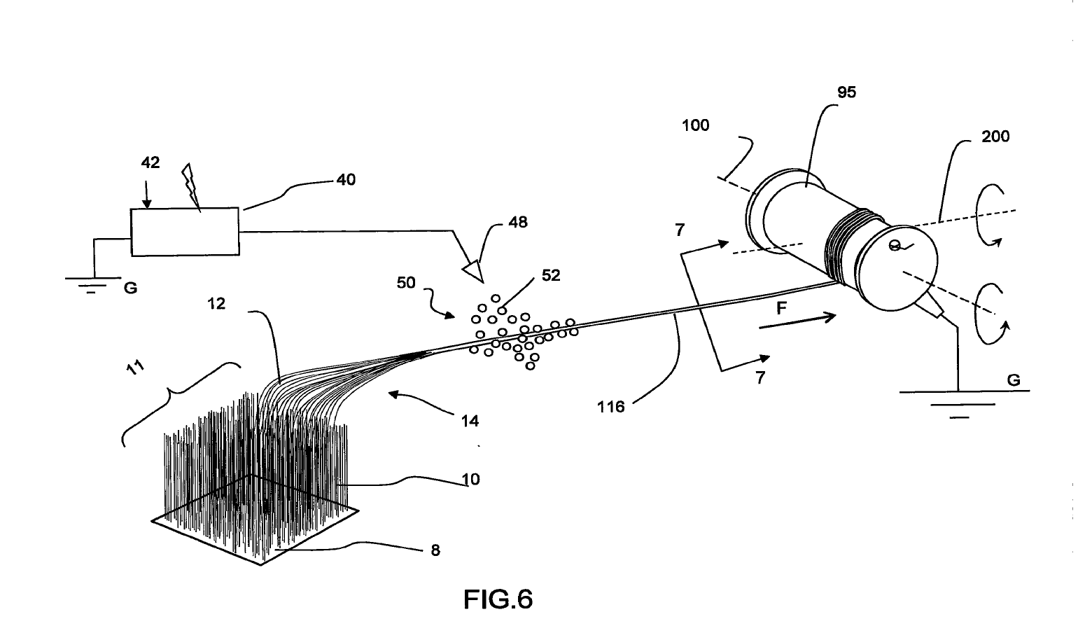

According to Lord Rayleigh, the formation of a charged jet according to the formula

$${r}_{j} = {( \frac{9 ɛ y}{2 {π}^{2}} )}^{1 / 3} {( \frac{F}{I} )}^{2 / 3} \qquad ( 1 )$$

where I is the injection current, F is the solution flow rate, ∈ is the permittivity of the solution, and γ is the surface tension. Typical electrostatic spraying operates by inducing a surface charge on the fluid being sprayed using an applied voltage. In many cases, however, the residual electrical conductivity of the fluid is inadequate to produce the large surface charge necessary for the formation of increasingly fine structures as in the case of most organic solvents applicable to spraying polymers. Attempting to generate fine sprays of certain organic solvents exhibiting a low dielectric constant (∈), can be difficult. In contrast, by using a sharp needle, electrons are injected into or removed from the fluid (field injection) producing an ionized solution having an increased capacity to carry surface charge in a process called field emission or field ionization, as shown in FIG. 6. Applied voltage ranges of 3-5 kV deliver a charge that collects at the meniscus surface of the solution, exerting increased electrical tension forces away from the nozzle. As a result, the size of a drop dripping off of the nozzle decreases and the frequency of drops increases; this is known as the drip mode. Once the electrical force increases up to and above 7 kV, the charged surface is disrupted into a smooth thin jet, which subsequently breaks-up into small, fairly uniform drops. Further raising of the voltage (to 9 kV) causes an increase in the number of polymer jets and a decrease in the size of the polymer droplets while maintaining a constant flow rate. Increasing the applied voltage up to 20-25 kV resulted in control of nanoparticle size to less than 300 nm. Increasing applied voltage produces a finer spray. Rayleigh's equation (Eq. (I)) indicates that increasing the current (I) carried by the polymer solution will decrease jet diameter. By increasing the voltage applied to the tungsten needle, the current was effectively controlled since V is related to I, holding other variables constant. When employing FFESS at high voltage, the relationship between I and V follows the Fowler-Nordheim equation I=AV² e^{(-B/V)}, where A and B are constants that depend on the geometry and material of the charge injection electrode. Regardless of the material, for a, sufficiently sharp needle operating at high voltages, I increases according to V² allowing high charging of the fluid being sprayed and invoking finer spray compared to conventional electrostatic spraying techniques, which rely largely on induction charging (I proportional to V) and, to a lesser degree, on field-injection charging. In conventional electrospraying, this latter charging cannot be controlled in a reproducible manner due to the non-uniform field-injection sites of the conventional hypodermic spray nozzle. Flow rates within the range of 0.01 to 10 mL/hr, per injection tip, Can be used.

Selection of the type of solvent used can influence the results. Multiple fluid properties are important including the polymer solution dielectric constant (∈) and surface tension (γ), which are accounted for in Rayleigh's equation, as well as the solution viscosity and solvent vapor pressure. The dielectric constant of the polymeric solution characterizes how much charge a non-ionized solution will hold and how fine a spray will result. Typical are polymeric solutions (polymers and/or solvents) having a higher dielectric constant of above 5, more typically above 20, and up to 40, and more typically up to or above 50. Solution surface tension is also an indicator of the amount of charge necessary to produce fine sprays. Typical are polymeric solutions (polymers and/or solvents) having a surface tension between about 15 and 30 (10⁻³ N/m). The ability of a polymer jet to break up is also a function of the solution viscosity, with low-viscosity streams more likely to form droplets. Typical are polymeric solutions (polymers and/or solvents) with a viscosity in the range of 0.25-5 mPa-sec, and preferably in the range of 0.5-1.2 mPa-sec. Finally, a solvent having low vapor pressure is better for forming continuous coatings as it is still in flowable form upon reaching the deposition surface on the CNT elongate, and the duration of the curing stage. The distance from the dispensing nozzle to the surface of the CNT elongate can be adjusted to increase or decrease drying time accordingly of the solvent during curing. Typical are polymeric solutions (polymers and/or solvents) having a vapor pressure between about 1 and about 20 kPa at ambient temperature and pressure.

Without being bound by any particular theory, the electrostatic charge facilitates not only deposition, but uniform deposition, of the coating solution droplets of the dispersion onto the surface of a grounded CNT elongate. The electrostatic charge of the contacting electrostatically-charged polymer solution droplets decays after contact with the grounded CNT elongate, and merge to form a continuous polymer solution coating. Without being bound by any particular theory, the meniscus formed by the coating of polymer material on and between adjacent, coated CNTs and CNT bundles of tubes, pulls the resulting CNT threads and CNT yarns into closer proximity, resulting in more tightly packed and denser CNT threads and yarns.

Another device and means for forming nano-scale droplets of polymer solution is described in, for example, Deng et al, J of Aerosol Science, vol 37, pp 696-714, 2006, the disclosure of which is incorporated by reference in its entirety. Deng et al describes a compact multiplexed electrospraying device and system that produces monodispersed, uniform size droplets of polymer solution. The device is made by micro fabricating in silicon by deep reaction ion etching (DRIE) of silicon wafers, to form micronozzles have a small, uniformly-sized internal flow diameter. The system significantly increases the liquid flow rate while maintaining the uniformity and nano/micro size of the charged droplets.

Another aspect of the invention is a process for producing strands of coated, or at least partially coated, CNT thread, yarn, braid, rope or wire in a continuous process, starting from arrays of aligned, elongated CNTs, or from pre-spun stock of CNT elongate, such as CNT.

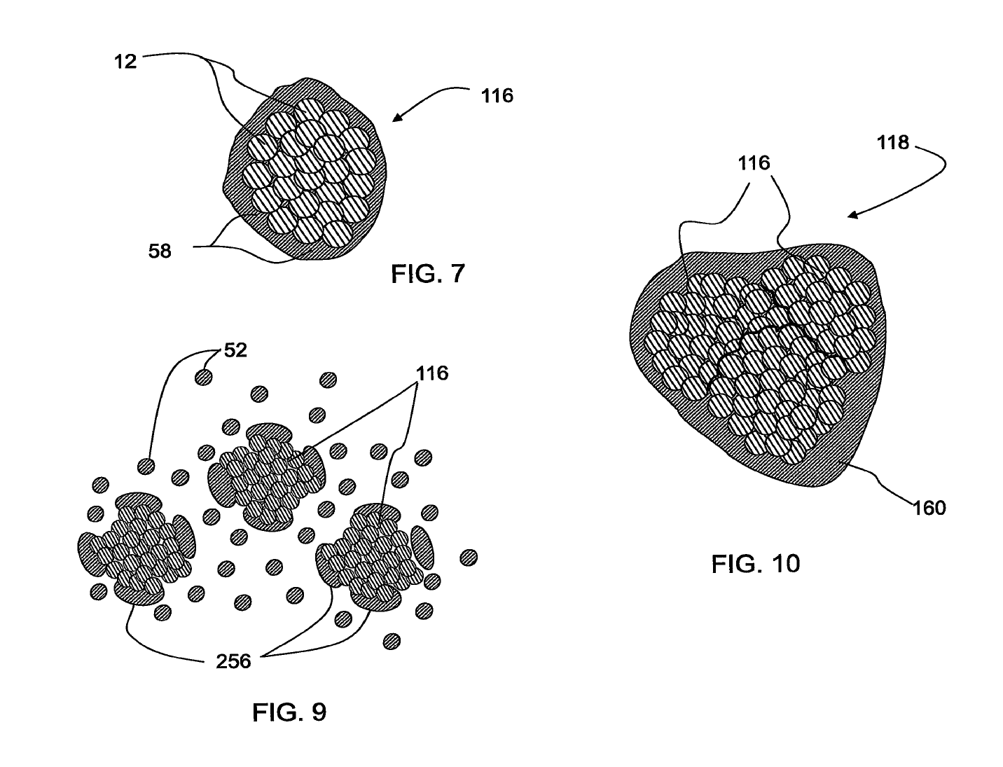

FIG. 6 illustrates an alternative embodiment of the method wherein the polymer solution droplets are guided and targeted just to the uncoated CNT thread 16, after the uncoated CNT strands 12 of the drawn ribbon 14 have been converged and spun into a thread. The polymer coating 58 substantially covers just the outside of the thread to form a coated thread 116, while the uncoated strands 12 in the interior portion of the coated thread 116 remain in direct lateral contact with one another and are not coated or separated by coating, as shown in FIG. 7. In this embodiment, the delivery head (nozzle tip) 48 is positioned toward the area downstream of where the thread 16 is formed, to direct and guide the droplets to that portion only of the CNT elongate.

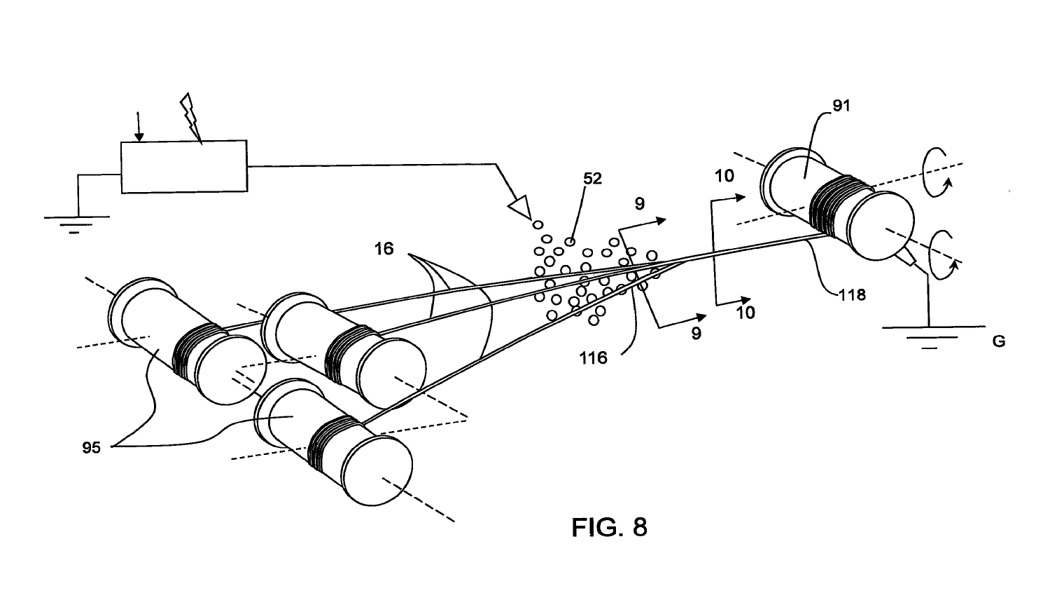

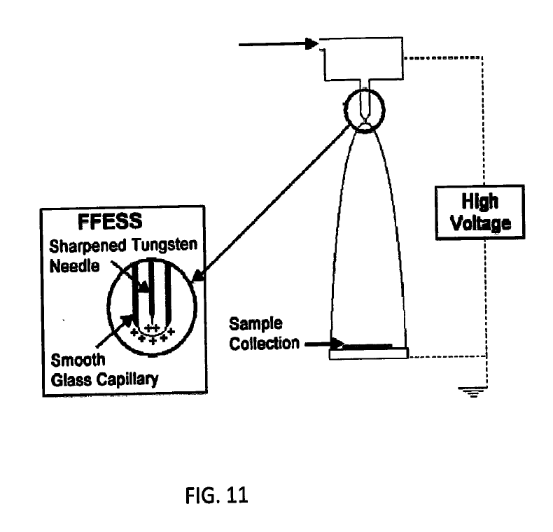

FIG. 8 illustrates an alternative embodiment of the method wherein a plurality (three) of uncoated CNT threads 16 have been produced, and are drawn off of separate collection spools 95 through a cloud 50 of statically-charged droplets 52. The collection spools 95 of uncoated (native) CNT thread 16 can be independently twisted or rotated in either clockwise or counterclockwise rotational direction while forming the yarn 118, which is shown grounded at take-up spool 91. Droplets 52 are drawn to and contact the outside surface of the grounded threads 16, as shown in FIG. 9, spreading and coating substantial portions of the threads to form coated threads 116 and a coated yarn 118, as shown in FIG. 10.

The illustrated embodiments also make clear that a plurality of forests 11 can be employed to draw a plurality of separate ribbons 14 through cloud(s) 50 of statically-charged coating droplets 52 to coat, the respective strands 12 of the ribbons 14. The coated threads 116 drawn from each forest 11 can be twisted or spun into the multi-thread coated yarn 118.

In addition to the solution or liquid polymer droplets, the present invention can also additional include electrostatically-charged particles comprised of a solid, made up of one or more compounds, that is not constrained to any particular shape. Such solid particles can be applied concurrently with, or successively after, coating of the CNT elongate by the polymer solution.

The contacting of the polymer solution to the surface of the CNT elongate is not limited to the outer surface of a CNT elongate, such as a thread or yarn, but can also include contacting the surfaces of individual CNTs below the outer surface of the CNT ribbon or threads, or any other surface created by arrangements of CNT's within a CNT elongate.

The character of the charge induced on the dispersed particles or droplets is not limiting in the invention, and can be negative, as exemplified, or positive.

Temperature of the processing zone may be relevant and the following ranges are suggested in the processing of electrostatically-charged solution onto CNT elongates; up to 500 degrees Fahrenheit, up to 400 degrees Fahrenheit, up to 300 degrees Fahrenheit, up to 200 degrees Fahrenheit, up to 100 degrees Fahrenheit; and at or above −300 degrees Fahrenheit, at or above −200 degrees Fahrenheit, at or above −100 degrees Fahrenheit, at or above 0 degrees Fahrenheit, at or above 32 degrees Fahrenheit, at or above 70 degrees Fahrenheit, at or above 100 degrees Fahrenheit, at or above 200 degrees Fahrenheit, at or above 300 degrees Fahrenheit, at or above 400 degrees Fahrenheit, at or above 500 degrees Fahrenheit, at or above 600 degrees Fahrenheit, at or above 700 degrees Fahrenheit, at or above 800 degrees Fahrenheit, at or above 900 degrees Fahrenheit, at or above 1000 degrees Fahrenheit, and at or above 1100 degrees Fahrenheit.

The dispersion and contacting process can be performed at ambient pressure, or at pressure or vacuum as needed. The process can also be performed in air, or in inert vapor atmospheres, for example argon, nitrogen, and others.

Dispersion particle size may be relevant and the following ranges are suggested: up to 500 μm, up to 100 μm, up to 50 μm, up to 5 μm, up to 1 μm, up to 900 nm, up to 800 nm, up to 700 nm, up to 600 nm, up to 500 rim, up to 400 nm, up to 300 rim, up to 200 nm, up to 100 nm, up to 50 nm; and at or above 10 nm, at or above 50 nm, at or above 100 nm, at or above 200 nm, at or above 300 nm, at or above 400 nm, at or above 500 nm, at or above 600 nm, at or above 700 rim, at or above 800 nm, at or above 900 nm, at or above 1 μm, at or above 2 at or above 3 μm, at or above 4 μm, at or above 7 μm, at or above 20 at or above 75 μm, at or above 150 μm, at or above 300 μm, and at or above 500 μm. Dispersion particle size, as described above, is affected by various properties of the polymeric solutions (polymers and/or solvents), including, but not limited to, flow rate, dispersion tip material and design, viscosity, dielectric constant, vapor pressure, and surface tension.

The uniform, thin coating that substantially covers the surface of a CNT elongate is characterized by a thin coating with a thickness up to 1000 nm, up to 500 nm, up to 100 nm, up to 90 nm, up to 80 nm, up to 70 nm, up to 60 nm, up to 50 nm, up to 40 nm, up to 30 nm, up to 20 nm, up to 10 nm, and at or above 5 nm, at or above 10 nm, at or above 20 nm, at or above 30 nm, at or above 40 rim, at or above 50 nm, at or above 60 nm, at or above 70 nm, at or above 80 rim, at or above 90 nm, at or above 100 nm, at or above 100 nm, or at or above 500 nm. The thickness of a coating can be assessed by electron scanning microscopy or other known means.

The ratio of the diameter of the elongate to the thickness of one layer of the coating is up to 10000 to 1, up to 5000 to 1, up to 1000 to 1, up to 800 to 1, up to 600 to 1, up to 400 to 1, up to 300 to 1, up to 200 to 1, up to 140 to 1, up to 80 to 1, up to 40 to 1, up to 20 to 1, up to 10 to 1, up to 8 to 1, up to 6 to 1, up to 4 to 1, and at or above 4 to 1, at or above 6 to 1, at or above 8 to 1, at or above 10 to 1, at or above 20 to 1, at or above 40 to 1, at or above 80 to 1, at or above 140 to 1, at or above 200 to 1, at or above 300 to 1, at or above 400 to 1, at or above 600 to 1, at or above 800 to 1, at or above 1000 to 1, at or above 5000 to 1, or at or above 10000 to 1.

The uniform thin coating substantially covering the surface of a CNT elongate is characterized by a uniform coating, where there is a coating while discounting the transition zones from uncoated to coated areas, with an average of the lowest 10% of coating thickness values within half the value of the average of the highest 10% of coating thickness values or with an average of up to 20% of the lowest coating thickness values within half the value of an average of up to 20% of the highest coating thickness values.

The coating may be a partial to a complete coating of the external surface of an elongate. The partial coating can range from 5%, from 10%, from 15%, from 20%, from 30%, from 40%, from 50%, from 60%, from 70%, from 80%, from 90%, to complete coverage of 95% or more of the external surface of the elongate. The extent of coverage necessary to establish complete coverage may be dependent on the particular use.

The following variables may impact charged droplet formation or behavior and include applied voltage, polymer solution flow rate, and solvent or polymer solution surface tension, viscosity, dielectric constant, and vapor pressure as noted in Berkland, Biomaterials 25 (2004) 5649-5658, discussed above. Typical applied voltages range from 3-30 kV. Typical polymer solution flow rates are determined experimentally and are highly dependent on equipment configuration as needed. Common ranges for polymer solution include a surface tension of 5-50×10⁻³ N/m, a viscosity of 0.1-0.8×10⁻³ Pa s, a dielectric constant of 2-50, and a vapor pressure of 5-50 kPa, which may impact desired droplet formation and spray behavior. Values of the parameters in combination of or outside of these ranges are envisaged as potentially relevant and the ranges are non-limiting.

Another aspect of the present invention includes a method wherein a second material or polymer, selected from but different from the first coating material or polymer, is dispersed, contacted with, and covers at least a portion of the fir coated CNT elongate. This method can include dispersing the two materials simultaneously during the same processing of CNT elongates, or sequentially, where the coated CNT elongate processed with the first material is re-processed and subsequently coated with the second material. The dispersing of both the first and second material during the same processing can include dispersing the two material at the same targeted CNT elongate, for example, at the ribbons and/or the threads, or at different targeted elongates, for example contacting the first material at the ribbons and the second material at just the thread or yarn.

Another aspect of the present invention includes a method wherein a solvent solution is first dispersed and contacted onto the surface of a CNT elongate, followed by the dispersing and contacting of the polymer or coating material to the CNT elongate, wherein solvent may serve as a wetting agent that aids in the flowing and coating of the polymer or coating material along the surface of the CNT elongate.

The electrostatic coating process offers numerous other advantages over conventional process for coating CNTs, including low energy expenditure, minimal pollution or other undesirable effluents, and high material utilization efficiencies, reduces waste, improves manufacturing efficiency and product quality, high recovery of charged particles onto the ribbon, little or no emissions, little or no overspray or mist of particles into the production line environment. Electrostatic coating process can be used on rapidly moving target lines, which will not slow or limit the CNT elongate spinning process.

### Example

### Example 1

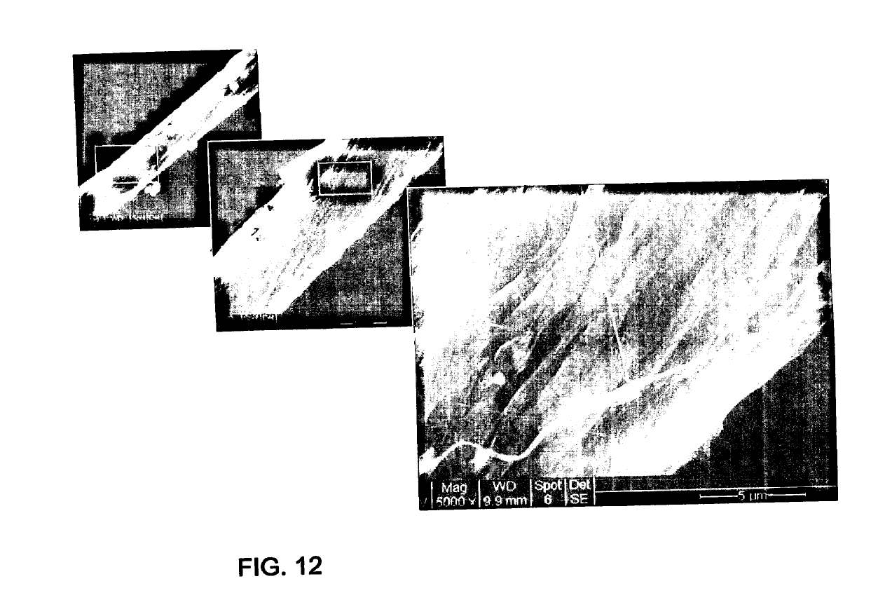

A CNT elongate is made composed of a CNT ribbon made by pulling loose CNTs from a forest of CNTs on the catalyst where the forest of CNTs are grown using a pair of standard tweezers. The CNTs were formed on a silicon wafer substrate using an Fe—Co alloy catalyst, and had a length of about 200 microns to about 1 mm. Substantially all of the CNTs were multi-walled CNTs. The coating composition was a butyrate polymer solution at 7.5% in toluene solvent. The dispersion of coating particles was made using a ceramic nozzle fed with a syringe pump. An electrostatic charge was induced using a Glassman high voltage power supply. The dispersion of coating particles was targeted at the ribbon of CNTs being pulled from the array. The coated CNT ribbon was concurrently twisted to form a coated CNT thread. Other than ambient evaporation from the coated CNT thread, no additional curing of the butyrate polymer was done. Electron micrographic images of a portion of the coated thread at three levels of magnification are shown in FIG. 12. The overall diameter of the thread was 17.9 microns; the resistance was 1157 ohms; the resistivity was 2.07 E-03 ohm-cm; the tensile strength was 0.395 GPa; and the elastic modulus was 2.2 GPa.

By comparison, the properties of an uncoated, spun CNT thread were a diameter of 10.9 microns; a resistance of 3448 ohms; a resistivity of 1.85E-03 ohm-cm; a tensile strength of 0.407 GPa; and an elastic modulus of 6 GPa.

### Example 2

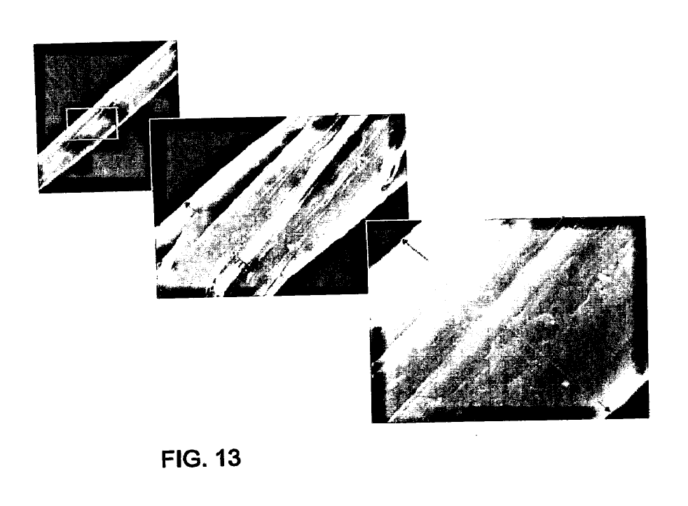

The method for coating a CNT elongates is repeated as in Example, 1, except that a two ceramic nozzles were used, and the dispersion of coating particles was targeted both at the ribbon and at the thread (or yarn) after the CNT ribbon had been drawn and spun into the thread. Electron micrographic images of a portion of the coated thread/yarn are shown in FIG. 13. The calculated diameter of the coated CNT thread in the middle image was 13.4 μm. The calculated diameter of the coated CNT thread in the bottom image was 12.8 μm. The overall diameter of the thread was 12.1 microns; the resistance was 6341 ohms; the resistivity was 4.69 E-03 ohm-cm; the tensile strength was 0.225 GPa; and the elastic modulus was 3.1 GPa.

1. A method of coating a carbon nanotube elongate, comprising the steps of:
(i) grounding a carbon nanotube (CNT) elongate,
(ii) dispersing statically-charged droplets of a polymer solution comprising a polymer in the vicinity of the grounded CNT elongate,
(iii) contacting the statically-charged droplets with the surface of the grounded CNT elongate,
(iv) maintaining the contacted droplets in contact with the surface of the grounded CNT elongate under conditions and for a time sufficient for the polymer solution to coat at least a portion of the surface, and
(v) optionally curing the coated polymer in the polymer solution.

2. The method according to claim 1 wherein the steps of contacting and coating result in complete coating of the surface of the ground CNT elongate

3. The method according to claim 1 wherein the polymer is an electrically insulating polymer, and the polymer solution comprises a solvent.

4. The method according to claim 1, wherein the CNT elongate is selected from the group consisting of a CNT ribbon, a CNT thread, a CNT yarn, a CNT braid, a CNT rope and a CNT wire.

5. A coated carbon nanotube (CNT) elongate comprising a CNT with coating of a polymer covering at least a portion of the surface of the CNT elongate.

6. The coated CNT elongate according to claim 5 wherein the polymer coating is a uniform and thin coating that covers the entire circumferential surface of the CNT elongate.

7. The coated CNT elongate according to claim 5, wherein the CNT elongate is selected from the group consisting of a CNT ribbon, a CNT thread, a CNT yarn, a CNT braid, a CNT rope and a CNT wire.

8. A method of depositing a particulate material onto the surface of a carbon nanotube (CNT) elongate, comprising the steps of:
(i) grounding a CNT elongate,
(ii) dispersing statically-charged particles of a material in the vicinity of the grounded CNT elongate,
(iii) contacting the statically-charged particles with the surface of the grounded CNT elongate, and
(iv) maintaining the contacted particles in contact with the surface of the grounded CNT elongate under conditions and for a time sufficient for the particle to affix to the surface.

9. The method according to claim 8 wherein the particulate material is a solid or liquid particle of an element, compound or composition.
